(19) United States
(12) Patent Application Publication
(10) Pub. No.: US 2020/0180228 A1
(43) Pub. Date: Jun. 11, 2020

(54) MICROSTRUCTURE-BASED TOPOLOGY OPTIMIZATION FOR STRUCTURAL COMPONENTS MADE BY ADDITIVE MANUFACTURING

(71) Applicant: MRL MATERIALS RESOURCES LLC, Beavercreek, OH (US)

(72) Inventors: Daniel P. Satko, Centerville, OH (US); Ayman A. Salem, Beavercreek, OH (US); Thomas Carmody, Dayton, OH (US)

(21) Appl. No.: 16/697,713

(22) Filed: Nov. 27, 2019

Related U.S. Application Data
(60) Provisional application No. 62/773,077, filed on Nov. 29, 2018.
(60) Provisional application No. 62/773,043, filed on Nov. 29, 2018.

(51) Int. Cl. B29C 64/386; B33Y 80/00; B33Y 50/00

(52) U.S. Cl. CPC B29C 64/386; B33Y 50/00; B33Y 80/00

(57) ABSTRACT

Devices that use additively-manufactured connectible unit cells are described in which each unit cell comprises materials and voids. The materials occupy a certain volume of the unit cell with the voids occupying the balance of the volume. The unit cells form a lattice structure, which exhibits smooth transitions between each of the adjacent unit cells. The lattice structure exhibits periodicity along one (1), two (2), or all three (3) dimensions. The materials have a thickness that is a function of the material location within the device.

### CROSS REFERENCE TO RELATED APPLICATIONS

This application claims the benefit of U.S. provisional patent application Ser. No. 62/773,077, filed Nov. 29, 2018, having the title “MICROSTRUCTURE-BASED TOPOLOGY OPTIMIZATION FOR STRUCTURAL COMPONENTS MADE BY ADDITIVE MANUFACTURING,” the disclosure of which is hereby incorporated by reference in its entirety, and claims the benefit of U.S. provisional patent application Ser. No. 62/773,043, filed Nov. 29, 2018, having the title “ADDITIVELY-MANUFACTURED GRADIENT GYROID LATTICE STRUCTURES”, the disclosure of which is hereby incorporated by reference in its entirety.

### STATEMENT REGARDING FEDERALLY SPONSORED RESEARCH OR DEVELOPMENT

This invention was made with government support under N6893618C0012 awarded by the U.S. Department of Defense. The government has certain rights in the invention.

### BACKGROUND

### Field of the Disclosure

The present disclosure relates generally to lattice structures and, more particularly, to additively-manufactured gradient gyroid lattice structures.

### Description of Related Art

Typically, hardware is manufactured using homogeneous materials. Because of the homogeneity of the materials, the mechanical properties of the hardware are likewise equally homogeneous. For specialized uses, however, the nearly-uniform mechanical properties across the hardware do not provide an optimal solution for that particular use. Consequently, there are ongoing efforts with reference to manufacturing specialized hardware.

### BRIEF SUMMARY

According to aspects of the present disclosure, devices are provided, which are formed from additively-manufactured connectible unit cells in which each unit cell comprises materials and voids. The materials occupy a certain volume of the unit cell with the voids occupying the balance of the volume. Moreover, the unit cells form a lattice structure, which exhibits smooth transitions between each of the adjacent unit cells. In some embodiments, the lattice structure exhibits periodicity along one dimension. In other embodiments, the lattice structure exhibits periodicity along two dimensions. In yet further embodiments the lattice structure exhibits periodicity along three dimensions. The materials have a thickness that is a function of the material location within the device.

According to further aspects of the present disclosure, a three-dimensional (3D) article of manufacture, comprises additively-manufactured infinitely-connectible gyroid unit cells, wherein each gyroid unit cell consists of materials that occupy positions within a portion of a volume of the unit cell. In this regard, the positions are defined by:

0=cos(x)sin(y)+cos(y)sin(z)+cos(z)sin(x), where:
x is a first dimension;
y is a second dimension; and
z is a third dimension.

Each gyroid unit cell also consists of voids that occupy a balance of the volume of the unit cell. The article of manufacture also comprises a lattice comprising the gyroid unit cells, wherein the lattice comprises substantially smooth transitions between adjacent gyroid unit cells, a first periodicity of the materials along x, a second periodicity of the materials along y, a third periodicity of the materials along z, a linearly-varying thickness of the materials along x, a gradually-varying thickness of the materials along y, and a gradually-varying thickness of the materials along z.

According to yet further aspects of the present disclosure, an article of manufacture comprises additively-manufactured connectible unit cells. In this regard, each unit cell comprises materials that occupy positions within a volume of the unit cell, and voids that occupy a balance of the volume. The article of manufacture also comprises a lattice comprising the unit cells, where the lattice comprises smooth transitions between adjacent unit cells, a first periodicity of the materials along a first dimension, a second periodicity of the materials along a second dimension, a third periodicity of the materials along a third dimension, and a thickness of the materials as a function of a material location within the article.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

FIG. 1 is a gyroid equation unit cell;

FIG. 2 is a gyroid with 70% void fraction and 30% solid density;

FIG. 3 is a gradient density lattice varying from 100% dense to only 10% dense;

FIG. 4 is a gyroid unit cell featuring a gradient lattice at varying gradients (a) 100-10%, (b) 100-20%, (c) 100-30%, (d) 100-40%;

FIG. 5 is a gradient gyroid lattice structure at varying gradients (a) 100-10%, (b) 100-20%, (c) 100-30%.

FIG. 6 is simulation results of the 100% to 10% gradient density gyroid. (a) displacement, (b) von mises stress, (c) equivalent strain;

FIG. 7 is simulation results of the 100% to 20% gradient density gyroid. (a) displacement, (b) von mises stress, (c) equivalent strain;

FIG. 8 is simulation results of the 100% to 30% gradient density gyroid. (a) displacement, (b) von mises stress, (c) equivalent strain;

FIG. 9 is a mesh refinement required for accurate FEM predictions of gradient gyroids with subtle density changes;

FIG. 10 is a gradient gyroid lattice changing density over a 1 mm distance;

FIG. 11 is an additive manufacture gradient gyroid lattice changing density over a 1 mm distance for a tension sample; and

FIG. 12A shows one example structure built using one or more techniques set out herein.

FIG. 12B shows another example structure built using one or more techniques set out herein.

FIG. 12C shows yet another example structure built using one or more techniques set out herein.

FIG. 12D shows yet another example structure built using one or more techniques set out herein.

### DETAILED DESCRIPTION

The applicant has demonstrated the ability to create optimized geometries for additively manufactured parts with its knowledge of the underlying microstructure of additive manufactured material and the role anisotropy plays in supporting external loads. In this regard, the applicant has developed two novel methods for TOAM including SAMP (Solid Anisotropic Material with Penalization) and SAM (Structured Anisotropic Material), whereby the first uses penalization to remove volumes that do not carry stresses while the second utilizes cellular structures with different densities in which volumes that does not carry stresses have very low densities and volumes carrying most of the stresses are giving relative density like the solid material.

Additive manufacturability of cellular structures with various densities became a practical challenge due to the abrupt transition from solid material to low density cellular structure. These areas of abrupt changes are sources of stress concentrations and could be sources of cracks upon aeroelastic loading. Thus, the applicant has developed a new type of cellular structure with “gradient” density changes and smooth transition with min stress concentration sites. In addition, the applicant has developed a method to manufacture these gradient cellular structures by additive manufacturing.

Accordingly, aspects herein provide implementations of gradient SAM. For maximum additive manufacturability, we have selected a unique unit cell for the cellular structure, namely the gyroid unit cell, which is an infinitely connected triply periodic minimal surface. In this regard, the applicant is currently believed to be the first to develop, design for additive manufacturability, and build a gradient gyroid cellular structure with adaptive densities that can be predicted by SAM. The applicant has also developed the generation of the mechanical behavior of the individual unit cells each with gradient density for feeding into FEM simulations via homogenization rules for fast calculations by NASTRAN.

Upon setting up SAM with gradient gyroids, the applicant can implement topology-optimized additive manufacturing (TOAM) for actual parts under aeroelastic loads and the design of the gradient gyroids enables the manufacturing process to avoid many additive manufacturing constrains such as overhangs.

### Sam Lattice Structure Element Design and Optimization Algorithm for Selecting Between Samp, Sam, and Simp within Toam

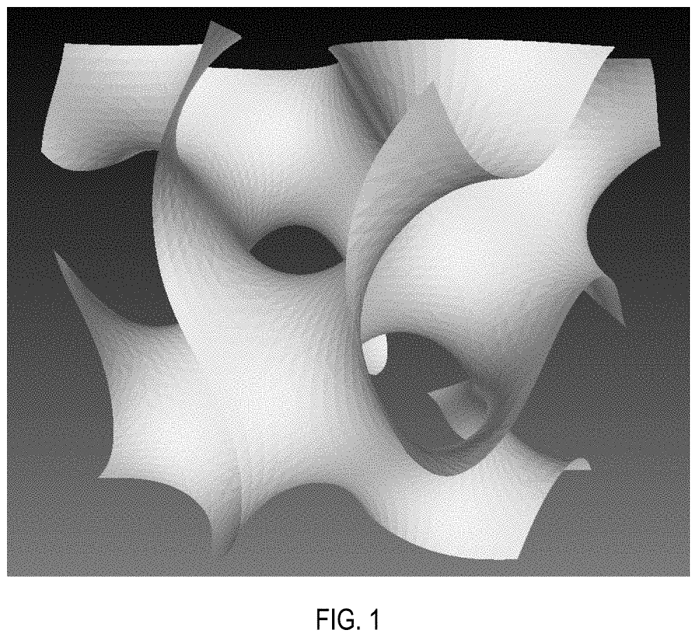

A selection of the unique cellular structure for integration into the finite element analysis software (NASTRAN) enables additive manufacturing of the TOAM designs with minimum support structures. The chosen geometry is a single unit cell of the gyroid triply periodic minimal surface as shown in FIG. 1. The three-dimensional periodic surface of a gyroid can be mathematically described using Equation 1.

Equation 1: 0=cos(x)sin(y)+cos(y)sin(z)+cos(z)sin(x) where x, y, and z are the spatial location for any pixel on the gyroid surface.

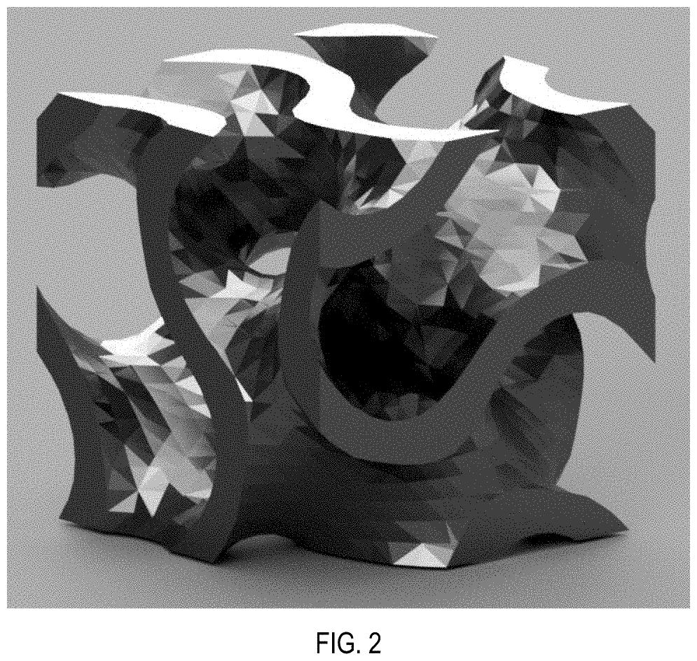

The above produces a surface (not a structure with a thickness), so aspects herein use a modified mathematical representation of Equation 1 to produce a gyroid with a thickness shown in FIG. 2. Such a volumetric shape with tailored thickness allows us to build it in our additive manufacturing machine with the thickness chosen to carry the needed load.

The gyroids are defined also by the void volume fraction which can be tailored mathematically and experimentally in an additive manufacturing machine to meet an optimized density based on SAM calculations. The problem of high stress concentrations at areas with density changes was a hinderance to implementation of gyroid designs.

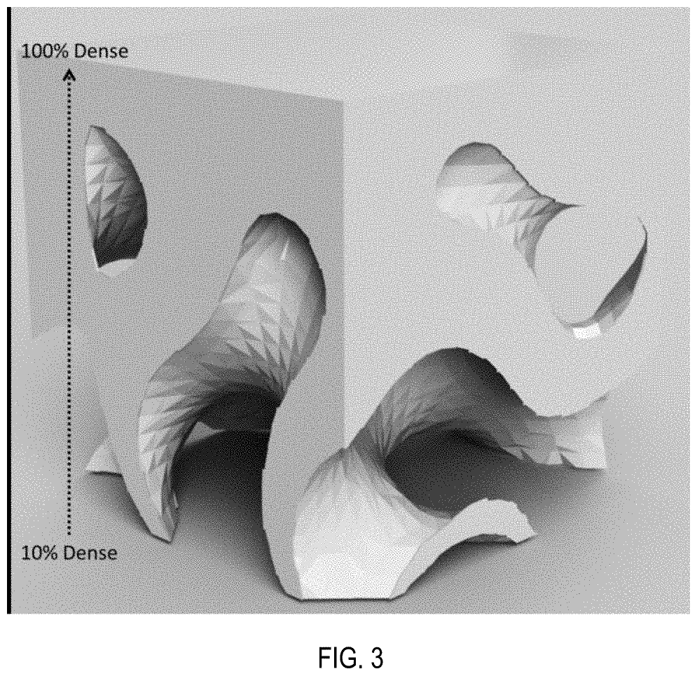

However, according to aspects herein, a solution is a gradual change of the density from solid parts to the required density. To accomplish this, the applicant has developed a Gyroid lattice structure that would have a density which changes based on its position, which is referred to herein as a “gyroids with gradient density.” For sake of clarity herein, the applicant has focused on linear unidirectional gradients, however the technique developed will scale easily, and the method can be applied amongst all axes and can follow complex paths rather than simple linear density changes. For practical applications, an assumption is made in an example implementation, of the minimum density to be 10% in gyroid lattice structures due to discontinuities in the resulting meshes. An example of the gradient structure can be seen in FIG. 3 with top surface attached to a solid material with a 100% density and the bottom volume at 10% density.

To insert into FEM, the applicant generated a new element set for FEM with homogenized properties for the gradient gyroids. To find these homogenized gyroid properties, the applicant numerically built many unit cells that were tested under compression simulating a compression test to generate stress-strain data to feed into FEM.

After producing this object, the applicant set up a tentative set of densities together that would produce an RVE for the mechanical behavior from the varying gradient densities.

FEM simulations will generate discrete flow curves for various gyroids. The applicant also utilized machine learning tools to generate continuous response surfaces from the discrete flow curves predicted by FEM. Thus, there is no requirement to rerun these simulations again. Rather, applications can use the BNN to predict any flow curve for even densities that were not initially used. Efficient training of the BNN require accurate sample. An example implementation used Latin Hypercube (LHC) Sampling so that the mechanical performance associated with the geometry can be fed to a Bayesian Neural network that will be capable of determining location-specific density requirements to meet the loading conditions imposed on a part, and these are summarized in Table 1. As previously mentioned, geometries that result in <10% dense part geometry are unstable for modelling, thus 10% density is the lower limit of the model.

TABLE 1
Latin hypercube sampled densities
for representative mechanical model

| Density Initial | Density Final |
|---|---|
| 0.427 | 0.754 |
| 0.537 | 0.155 |
| 0.317 | 0.488 |
| 0.706 | 0.577 |
| 0.636 | 0.960 |
| 0.752 | 0.368 |
| 0.888 | 0.250 |
| 0.960 | 0.692 |
| 0.218 | 0.886 |
| 0.158 | 0.442 |

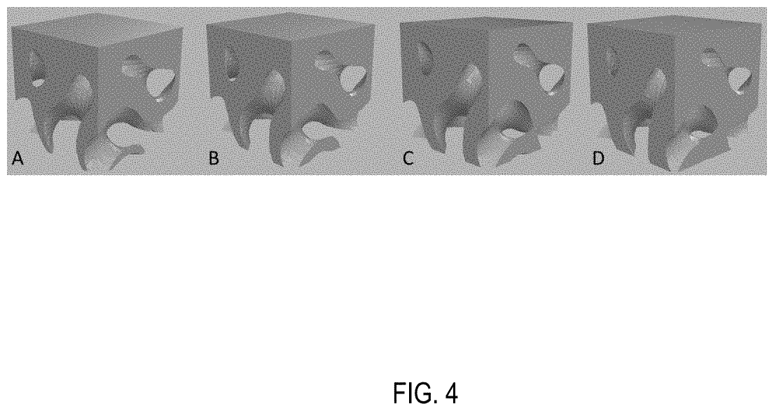

While Table 1, holds the tentative Latin hypercube sampled densities, the applicant ensured that the geometries could be modeled well under load. To do this, the applicant simulated the cases shown in FIG. 4.

To predict the mechanical behavior of these different unit cells, the applicant has developed a procedure that will allow it to determine the stress-strain curves as a function of the density using a Bayesian Neural Network, which will then propagate the mechanical behavior to tailor a unique density calculated by TOAM using SAM method that will result in the desired part performance with minimum mass.

### Finite Element Simulation of Gradient Gyroid Compression Testing

The FEM simulations is a virtual compression test in which each of the lattices outlined in Table 1 is compressed. This enables the production of stress-strain curves that represent the entirety of all possible density gradients.

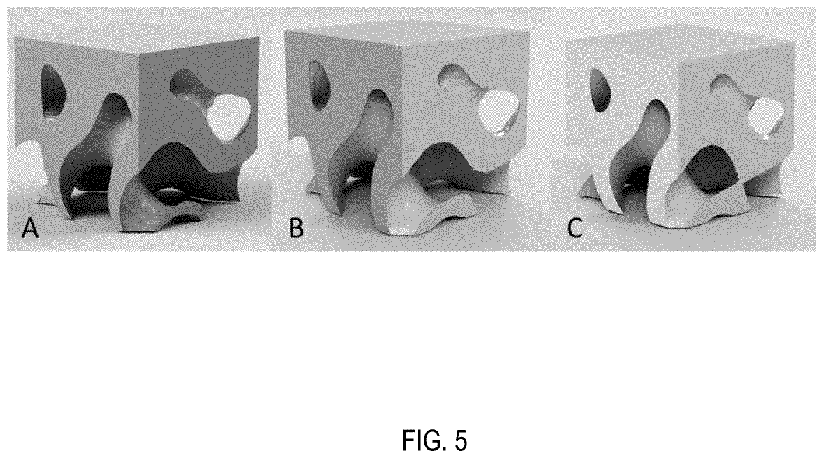

In an example implementation, the applicant has completed FEM simulations of single-cell gyroid lattices which have densities going from 100-10%, 100-20%, and 100-30% densities respectively. In each simulation, the single cell lattice was subject to the same condition that a load will be applied that will result in a 3% displacement at a strain rate of 0.001. For the 100-10% gyroid, it is clear that with the smaller area available to receive the load, there will therefore be increased stresses at lower loads, that is why the load is not fixed, and rather, displacement is. The simulations were done on the geometries shown in FIG. 5.

The simulations resulted in a maximum load of 5.98 N, 26.76 N, and 79.2 N for the A, B, and C respectively. It is unsurprising that C would have been able to receive the largest load before 3% displacement because it was the most-dense of the three. The distribution of stresses however can be seen in the following figures.

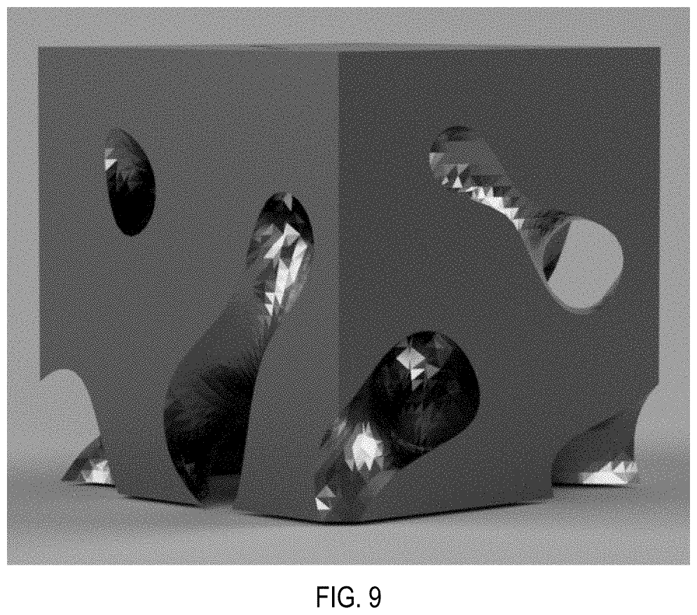

In producing the FEM meshes, subtle changes in density may require higher resolution meshing of the gradient gyroids. Such a fine mesh is shown in FIG. 9.

### Additive Manufacturability of Gradient Gyroids

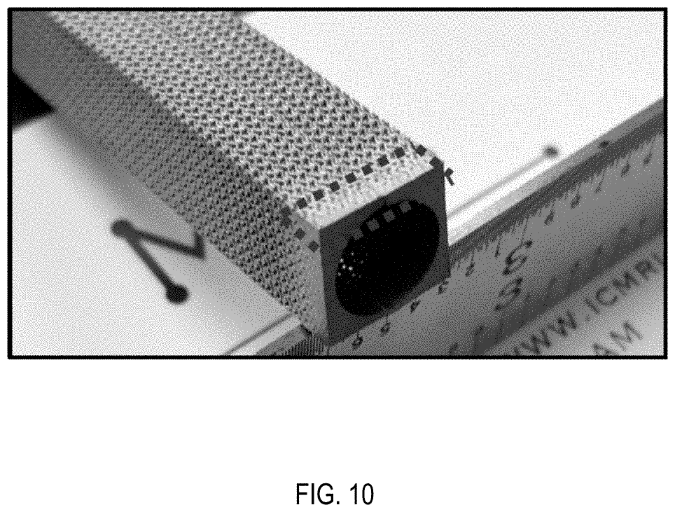

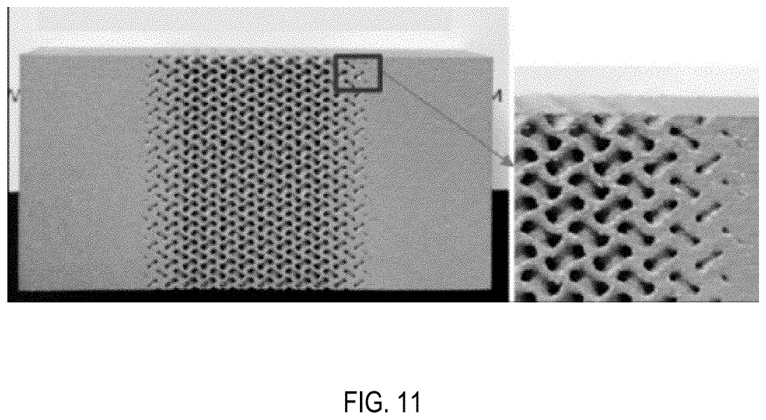

The applicant has also been successful in its manufacture of these gyroids with gradient density parts and FIG. 10 shows a cuboid with internal cylinder made of gradient gyroid with density changes along the cylinder axis 100% to 30% density change occurring over 1 mm. To capture the behavior of the gradient gyroid under tensile load, the applicant has built a block of tensile samples with the gyroid density gradually changes form the grip section to the gauge (FIG. 11) 100% to 30% density change occurring over 1 mm. The gyroids are also sized such that one-unit cell occupies a 1×1×1 mm volume. The builds were very successful and required no additional support structures due to their intrinsically supporting nature, one of the favorable attributes of gradient gyroids.

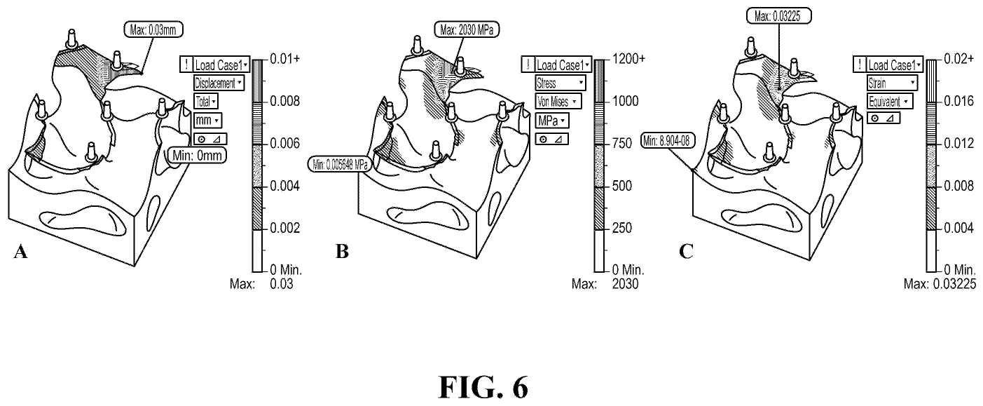

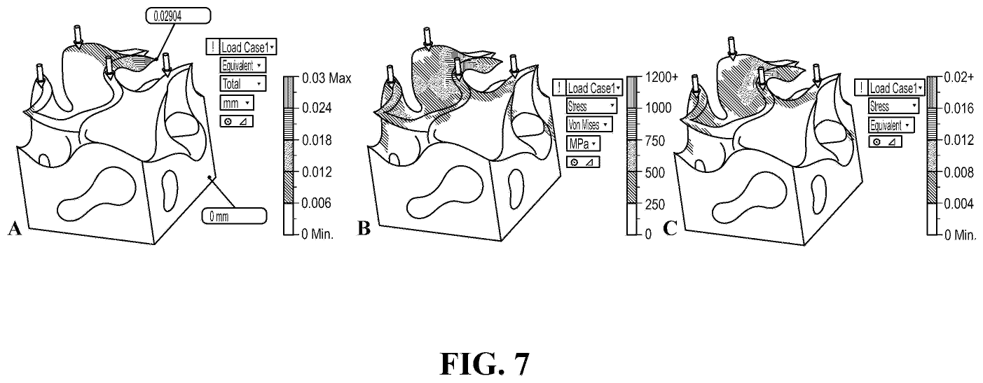

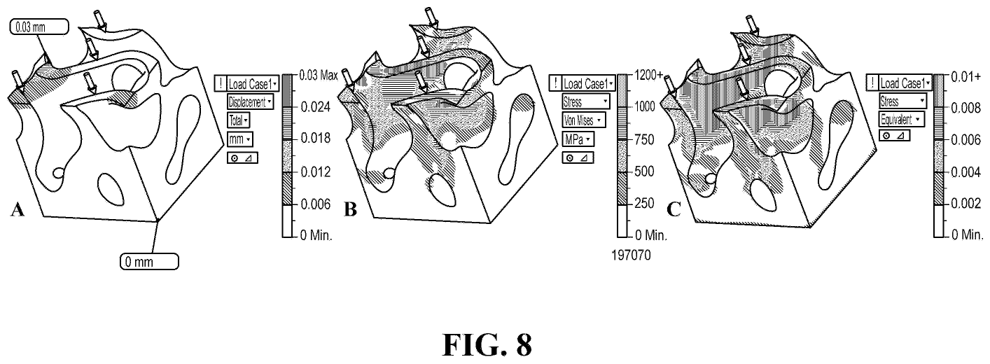

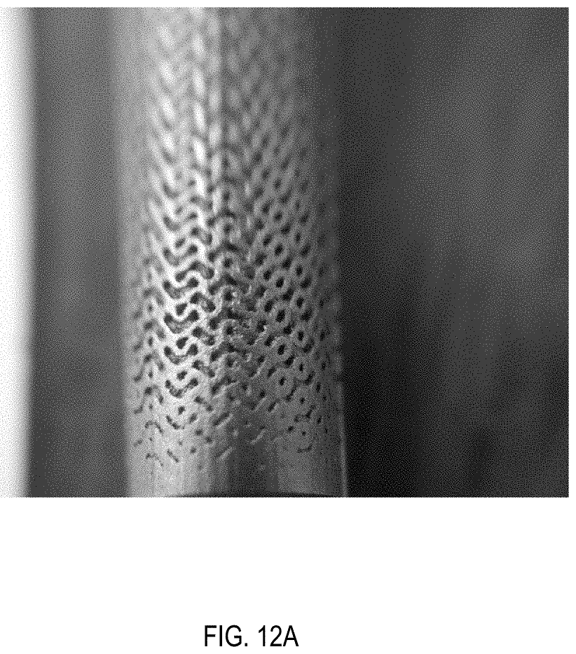

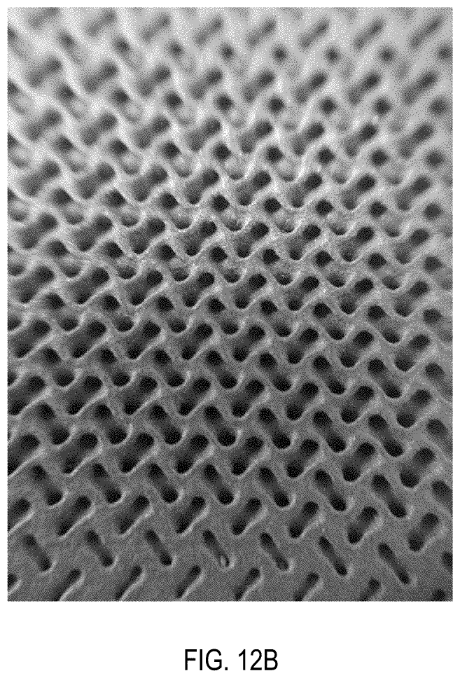

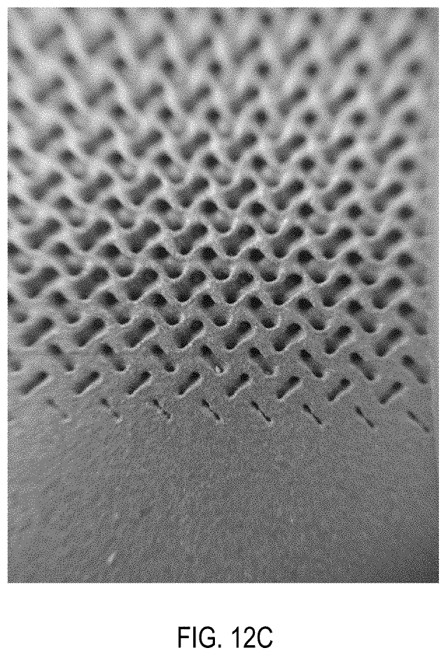

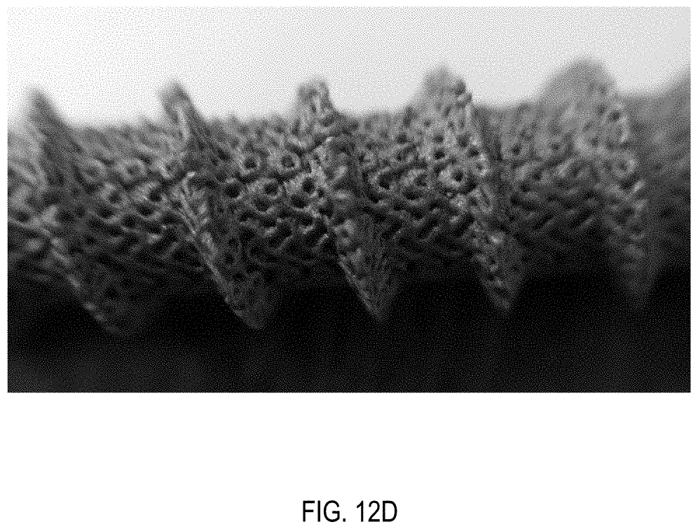

Furthermore, as shown in FIGS. 12A, 12B, 12C, and 12D, various different structures are manufacturable from the cells and lattices described with reference to FIGS. 1 through 11.

Although a gradient gyroid lattice structure is shown and described above, it should be appreciated that any triply periodic structure (along x, y, and z) also achieves similar benefits as the gyroid lattice structure. Consequently, the gyroid lattice structure is extendable generally to a three-dimensional (3D) article of manufacture, which is additively manufactured using infinitely connectible triply periodic unit cells. Each triply periodic unit cell comprises materials that occupy positions within a portion of a volume of the unit cell. In this regard, the positions are defined by:

0=cos(Pₓᵢ*xᵢ)sin(P_{yi}*yᵢ)+cos(P_{yi}*yᵢ)sin(P_{zi}*zᵢ)+cos(P_{zi}*zᵢ)sin(Pₓᵢ*xᵢ)−T²_{xyzi} [Eq. 2],

where:
i is an integer that represents the unit cell number (e.g., i=1 is the first unit cell, i=2 is the second unit cell, etc.);
x is a first dimension;
y is a second dimension;
z is a third dimension;
Pₓ is 2π times the periodicity in the x direction;
P_{y} is 2π times the periodicity in the y direction;
P_{z} is 2π times the periodicity in the z direction; and
T is a thickness.

Each triply periodic unit cell also comprises voids that occupy a balance of the volume of the unit cell. The article of manufacture also comprises a lattice comprising the triply periodic unit cells, wherein the lattice comprises substantially smooth transitions between adjacent triply periodic unit cells. As one can appreciate, the thickness of the material can be constant along x, linearly varying along x, or gradually varying along x, y, or z, or any combination thereof.

Because cell density is a function of the material-to-void ratio, one way of expressing density (ρ) is as a function of thickness, such as, for example:

ρᵢ=f(Tᵢ) [Eq. 3].

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the invention in the form disclosed. Many modifications and variations will be apparent to those of ordinary skill in the art without departing from the scope and spirit of the invention. Aspects of the disclosure were chosen and described in order to best explain the principles of the invention and the practical application, and to enable others of ordinary skill in the art to understand the invention for various embodiments with various modifications as are suited to the particular use contemplated.

What is claimed is:

1. A three-dimensional (3D) article of manufacture, comprising:
additively-manufactured infinitely-connectible gyroid unit cells, wherein each gyroid unit cell comprises
materials that occupy positions within a portion of a volume of the unit cell, wherein the positions are defined by:
0=cos(x)sin(y)+cos(y)sin(z)+cos(z)sin(x), wherein:
x is a first dimension;
y is a second dimension; and
z is a third dimension; and
voids that occupy a balance of the volume of the unit cell;
a lattice comprising the gyroid unit cells, wherein the lattice comprises:
substantially smooth transitions between adjacent gyroid unit cells;
a first periodicity of the materials along x;
a second periodicity of the materials along y;
a third periodicity of the materials along z;
a linearly-varying thickness of the materials along x;
a gradually-varying thickness of the materials along y; and
a gradually-varying thickness of the materials along z.

2. An article of manufacture, comprising:
additively-manufactured connectible unit cells, wherein each unit cell comprises:
materials that occupy positions within a volume of the unit cell; and
voids that occupy a balance of the volume;
a lattice comprising the unit cells, wherein the lattice comprises:
smooth transitions between adjacent unit cells;
a first periodicity of the materials along a first dimension;
a second periodicity of the materials along a second dimension;
a third periodicity of the materials along a third dimension; and
a thickness of the materials as a function of a material location within the article.

3. The article of manufacture of claim 2, wherein the positions that the materials occupy are defined by:
0=cos(x)sin(y)+cos(y)sin(z)+cos(z)sin(x), wherein:
x is a first dimension;
y is a second dimension; and
z is a third dimension.

4. The article of manufacture of claim 2, wherein the infinitely-connectible unit cells comprise gyroid unit cells.

5. The article of manufacture of claim 2, wherein the thickness of the materials varies linearly as a function of its location along the first dimension.

6. The article of manufacture of claim 2, wherein the thickness of the materials varies linearly as a function of its location along the second dimension.

7. The article of manufacture of claim 2, wherein the thickness of the materials varies linearly as a function of its location along the third dimension.

8. The article of manufacture of claim 2, wherein the thickness of the materials varies linearly as a function of its location along at least two (2) of the three (3) dimensions.

9. The article of manufacture of claim 2, wherein the thickness of the materials varies linearly as a function of its location along all the three (3) dimensions.

10. The article of manufacture of claim 2, wherein the thickness of the materials varies non-linearly as a function of its location along the first dimension.

11. The article of manufacture of claim 2, wherein the thickness of the materials varies non-linearly as a function of its location along the second dimension.

12. The article of manufacture of claim 2, wherein the thickness of the materials varies non-linearly as a function of its location along the third dimension.

13. The article of manufacture of claim 2, wherein the thickness of the materials varies non-linearly as a function of its location along at least two (2) of the three (3) dimensions.

14. The article of manufacture of claim 2, wherein the thickness of the materials varies non-linearly as a function of its location along all the three (3) dimensions.

15. The article of manufacture of claim 2, further comprising a density that is calculated as a ratio of a volume of the materials within the unit cell to the volume of the unit cell, wherein the density is a function of the material location, wherein the density is between approximately ten percent (10%) and approximately one hundred percent (100%).

16. The article of manufacture of claim 2, further comprising a density that is calculated as a ratio of a volume of the materials within the unit cell to the volume of the unit cell, wherein the density is a function of the material location, wherein the density is between approximately twenty percent (20%) and approximately one hundred percent (100%).

17. The article of manufacture of claim 2, further comprising a density that is calculated as a ratio of a volume of the materials within the unit cell to the volume of the unit cell, wherein the density is a function of the material location, wherein the density is between approximately thirty percent (30%) and approximately one hundred percent (100%).

18. The article of manufacture of claim 2, wherein the article of manufacture exhibits an average stress across the article when a load is applied to the article, wherein the material location comprises:
higher-stress locations exhibiting stresses that are higher than the average stress; and
lower-stress locations exhibiting stress that are lower than the average stress.

19. The article of manufacture of claim 18, further comprising densities calculated as a ratio of a volume of the materials in the unit cell to a total volume of the unit cell, wherein the densities comprise:
an average density;
higher densities that are higher than the average density; and
lower densities that are lower than the average density.

20. The article of manufacture of claim 19, wherein:
the higher-stress locations exhibit higher densities; and
the lower-stress locations exhibit lower densities.
